(19) United States
(12) Patent Application Publication
(10) Pub. No.: US 2018/0115029 A1
(43) Pub. Date: Apr. 26, 2018

(54) SMART SYSTEM AND METHOD FOR CONTROLLING BATTERY PACK TEMPERATURE OF ELECTRIC VEHICLE

(71) Applicant: NIO NEXTEV LIMITED, Hong Kong (CN)

(72) Inventors: Yi REN, Shanghai (CN); Bin HE, Shanghai (CN)

(21) Appl. No.: 15/792,115

(22) Filed: Oct. 24, 2017

(30) Foreign Application Priority Data
Oct. 25, 2016 (CN) 201610985191.0

(51) Int. Cl. H01M 10/63; H01M 10/663; H01M 10/613; H01M 10/625; H01M 10/6551; H01M 10/6567; H01M 10/657; H01M 10/48; B60L 11/18

(52) U.S. Cl. CPC H01M 10/63; H01M 10/663; H01M 10/613; H01M 10/625; H01M 10/6551; B60L 2240/36; H01M 10/657; H01M 10/486; B60L 11/1874; B60L 11/1861; H01M 10/6567

(57) ABSTRACT

The present application relates to electric vehicle field, particularly to a smart system and method for controlling battery pack temperature of an electric vehicle. The application aims at solving the problem of extending the battery pack lifespan of an electric vehicle. To this end, the method of the application includes: when the vehicle is powered, determining whether the duration of the thermal management operation is longer than a predetermined threshold; if the duration is no longer than the threshold, determining whether the battery is in connection with a charging post; if yes, assessing the temperature of the battery; if not, assessing the battery SOC; the assessment result of the battery temperature is compared with a target temperature or preset temperature range, and based on the comparison, the following operations are executed: the thermal management operation is stopped, the thermal manage system directs the cooling liquid to the cooling device or the heat sink. The present application is able to selectively cool the battery pack based on its real time state and therefore extend lifespan of the pack without increasing costs.

### CROSS-REFERENCE TO RELATED APPLICATIONS

This application claims the benefit of China Patent Application No. 201610985191.0 filed Oct. 25, 2016, the entire contents of which are incorporated herein by reference.

### TECHNICAL FIELD

The present application relates to the field of new energy vehicle, particularly to smart system and method for controlling battery pack temperature of electric vehicle.

### BACKGROUND

Nowadays, most vehicles in the world are equipped with traditional internal combustion engines, by means of which the vehicles are powered by fossil fuel (petroleum for example). The use of such internal combustion engines however also brings about environmental problems, such as warming climate. In place of traditional internal combustion engines powering vehicles, battery packs used as energy storing systems of electric-only vehicles greatly relieve the environmental problems caused by the traditional internal combustion engines. Yet popularity of electric vehicles requires improvements in such desired aspects as vehicle performance, driving range, durability, lifespan and costs. The battery pack, as the most important component of an electric vehicle, is a decisive factor for popularity of electric vehicles.

The application aims to optimize battery packs and thus extend their lifespan, which is closely related to the storing temperature. In particular, as shown in FIG. 1, the expected lifetime of a battery pack will almost not be impacted throughout the storing duration at the temperature of 0 degree Celsius, the expected lifespan of stored battery pack shortens slightly as time goes by at 20° C., the predicted lifespan of stored battery pack is obviously reduced over time at 40° C., and at the storing temperature of 60° C., the expected lifetime of battery is drastically driven down. Then it can be seen that when an electric vehicle is powered off, that is to say, when its battery pack stops working, temperature's adverse effect on battery lifespan can be avoided by controlling the temperature of the battery pack (cooling the battery pack for example).

Therefore, there is a need for a system and method in this field, which is able to extend the battery pack lifespan by cooling it after the electric vehicle is powered off.

### SUMMARY

To solve the above mentioned problems in the prior art, i.e., the problems of how to extend the battery pack's lifetime of an electric vehicle, the application provides a smart system for controlling the battery pack temperature of an electric vehicle. The smart control system comprises a battery cooling system, a vehicle air conditioning system and a cooling device, both cooling liquid of the battery cooling system and coolant of the vehicle air conditioning system flow through the cooling device and exchange heat within the cooling device; the battery cooling system includes a heat sink to dissipate heat from the cooling liquid and a selector valve used for directing the cooling liquid into the cooling device or the heat sink.

In a preferred embodiment of the above smart system, the battery cooling system further includes a pump to circulate the cooling liquid.

In a preferred embodiment of the above smart system, the battery cooling system further includes a high voltage heater connected in parallel with the heat sink and used for heating the cooling liquid which can also be led to the high voltage heater by controlling the selector valve.

In a preferred embodiment of the above smart system, the vehicle air conditioning system includes a compressor, a condenser, an expansion valve, and a dryer/separator communicated with one another, coolant is first compressed by the compressor, then passes through the condenser and is liquefied, thereafter, the coolant passes through the expansion valve to bring down its temperature and pressure and flows into the cooling device, within which heat exchange happens between the coolant and the cooling liquid, the coolant then travels through the dryer/separator and finally enters back to the compressor in gas state, completing a whole circulation.

In a preferred embodiment of the above smart system, the vehicle air conditioning system further includes a cooling fan, which operates in cooperation with the condenser to improve the performance of the condenser.

In a preferred embodiment of the above smart system, the smart control system further includes a battery thermal management system, which is used for monitoring battery temperature and controlling the selector valve according to the battery temperature so as to lead the cooling liquid into the cooling device, the heat sink or the high voltage heater.

The present application also provides a smart control method used for the above smart systems, the smart control method comprises the following steps: when the vehicle is powered off, determining whether the duration of the thermal management operation is longer than a predetermined threshold; suspending the thermal management operation, if the duration is longer than the threshold; if the duration is no longer than the threshold, determining whether the battery is in charging state or not; if the battery is in charging state, assessing the temperature of the battery; if the battery is not in charging state, assessing the battery SOC and choosing to stop the thermal management operation or assess the battery temperature in accordance with the assessment of the battery SOC; comparing the assessment result of the battery temperature with a target temperature or preset temperature range, and executing the following operations based on the comparison: stop the thermal management operation, the thermal manage system directs the cooling liquid to the cooling device or the heat sink by controlling the selector valve.

In a preferred embodiment of the above smart control method, the step of if the battery is in charging state, assessing the temperature of the battery, further includes the following steps: comparing the current battery temperature with the preset temperature range; if the current battery temperature is below the preset temperature range, stopping the thermal management operation; if the current battery temperature is within the preset temperature range, the thermal management operation system controls the selector valve to lead the cooling liquid to the heat sink; if the current battery temperature is above the preset temperature range, the thermal management operation system controls the selector valve to direct the cooling liquid to the cooling device and opens the vehicle air conditioning system at the same time.

In a preferred embodiment of the above smart control method, the step of if the battery is not in charging state, assessing the battery SOC and choosing to stop the thermal management operation or assess the battery temperature in accordance with the assessment of the battery SOC, further includes the following steps: comparing the current battery SOC with the preset battery SOC range; if the current battery SOC is below the preset battery SOC range, stopping the thermal management operation; if the current battery SOC is within or above the preset battery SOC range, then assessing the battery temperature.

In a preferred embodiment of the above smart control method, the step of if the current battery SOC is within the preset battery SOC range, then assessing the battery temperature, further includes the following steps: comparing the battery temperature with a target temperature; if the battery temperature is below the target temperature, then stopping the thermal management operation; if the battery temperature is above the target temperature, then controlling the selector valve to direct the cooling liquid to the heat sink.

In a preferred embodiment of the above smart control method, the step of if the current battery SOC is above the preset battery SOC range, then assessing the battery temperature, further includes the following steps: comparing the battery temperature with a preset temperature range; if the battery temperature is below the preset temperature range, stopping the thermal management operation; if the battery temperature is within the preset temperature range, the thermal management system controls the selector valve to direct the cooling liquid to the heat sink; if the current battery temperature is above the preset temperature range, the thermal management system controls the selector valve to direct the cooling liquid to the cooling device and opens the vehicle air conditioning system at the same time.

In a preferred embodiment of the above smart control method, the preset battery SOC range comprises 10%-80%, 20%-60% or 25%-45%.

In the technical solutions of the application, by cooling the battery pack, temperature's adverse impact on the battery is eliminated and the lifespan of the battery is thus extended. Battery packs can be cooled by the battery cooling system of the application with aid of a heat sink or a vehicle air conditioning system. The smart control method of the application can assess the temperature of a battery after determining whether the battery is connected to a charging post or not and obtaining the battery SOC state, thereby choosing a suitable cooling way according to different battery temperatures. Therefore, the application is able to selectively cool a battery pack according to its real time state to extend the lifetime of the battery pack without increasing costs.

### BRIEF DESCRIPTION OF DRAWINGS

FIG. 1 is a schematic view showing variations in battery discharge capacity over time at different storing temperatures;

FIG. 2 is a structural schematic view of various systems of electric vehicle related to energy storing systems;

FIG. 3 is a structural schematic view of the smart system for controlling battery pack temperature of an electric vehicle of the present application; and

FIG. 4 is a flow chart of the smart method for controlling battery pack temperature of an electric vehicle of the present application.

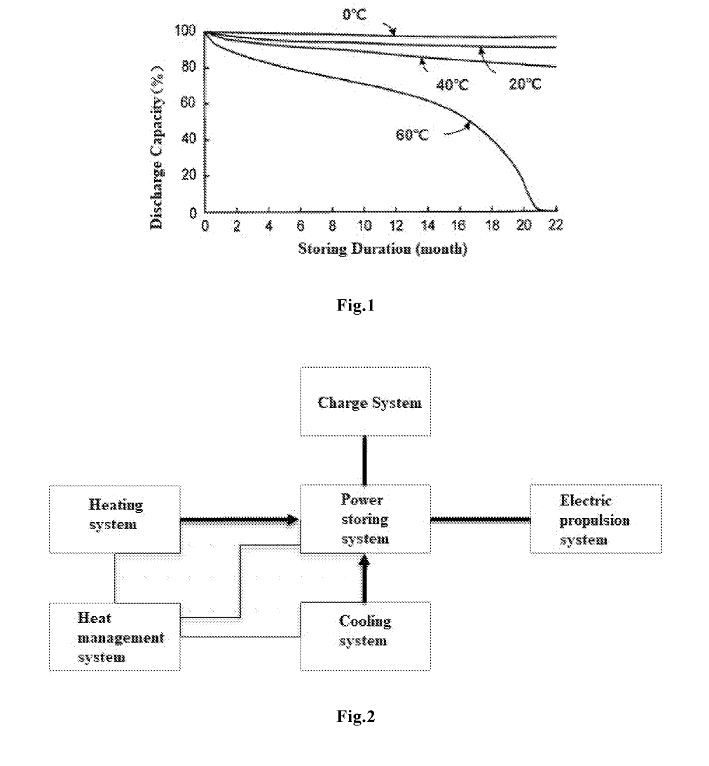

### DETAILED DESCRIPTION

The preferred embodiments of the application are described below with reference to the accompanying figures. As will be understood by those skilled in the art, these embodiments are simply used for interpreting the technical principle of the application and are not intended to limit its protection scope in any way.

It can be seen from the description in the background that the lifespan of a battery park is closely related to its storing temperature. Accordingly, the present application aims to extend the lifespan of a battery pack by eliminating temperature's adverse impact on it. With reference to FIG. 2, FIG. 2 is a structural schematic view of the systems related to a power storing system in electric-only vehicle. As shown in FIG. 2, the power storing system in electric-only vehicle is a battery pack, which turns its electric energy into kinetic energy of the electric vehicle with aid of an electric propulsion system. The electric propulsion system consists of one or more motors and power electric modules, which usually include inverter(s) to convert direct current to alternating current. The battery pack is charged by a charging system, which generally includes an on-board charger, high voltage harnesses, connecting harnesses and a charging post and charges the battery under direct voltage or alternating voltage. Additionally, the battery pack further includes a heat management system which is used for monitoring its real time state and able to adjust its temperature by means of a battery cooling system or battery heating system according to its current temperature. On this basis, the application provides a smart system and method for controlling temperature of battery pack of an electric vehicle; the system and method are able to eliminate the adverse effect on the lifespan of the battery pack after it is powered off by controlling its temperature, thus extending the lifespan of the battery pack.

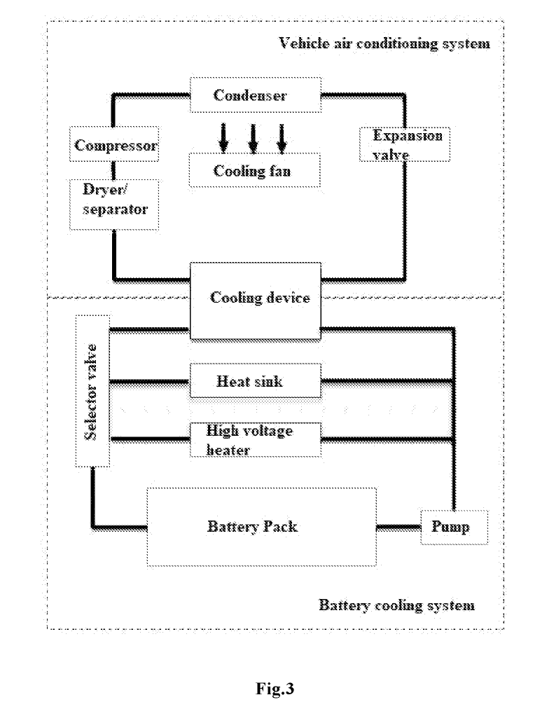

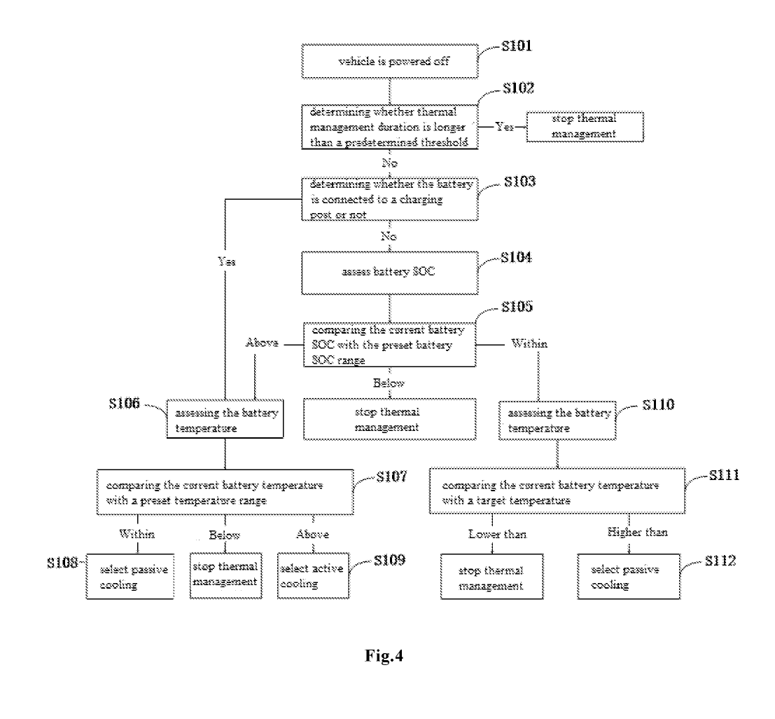

With reference to FIG. 3, FIG. 3 is a structural schematic view of the smart system for controlling temperature of battery pack of an electric vehicle. As shown in FIG. 3, the present smart control system comprises a battery cooling system, a vehicle air conditioning system and a cooling device, with help of which heat exchange between the battery cooling system and the vehicle air conditioning system is realized. Specifically, the vehicle air conditioning system includes a compressor, a condenser, an expansion valve, the cooling device and a dryer/separator successively communicated with one another, and works in the following way: coolant is first compressed by the compressor into high temperature vapor, which then passes through the condenser and is liquefied due to heat dissipation, thereafter, the coolant still remains in state of high temperature and high pressure and passes through the expansion valve, hence both its temperature and pressure are brought down, this drop in temperature and pressure can be controlled by adjusting the flow rate of the expansion valve which is capable of lowering the temperature and pressure of the coolant at the same time. Heat exchange between the cooling device and the battery cooling system is realized by means of the coolant which absorbs heat and is partly or completely turned into gas. The gas coolant is separated by the dryer/separator from the liquid and enters the compressor, the cycle repeats itself. Further, in order to improve the performance of the condenser, a cooling fan can be provided near the condenser to accelerate cooling of the high temperature vapor.

As shown in FIG. 3, the battery cooling system includes a heat sink and a selector valve. Specifically, the flow direction of the cooling liquid in the battery cooling system is controlled by the selector valve, the exit of which can be controlled to direct the cooling liquid flow to the cooling device through which the coolant in the vehicle air conditioning system also passes. Within the cooling device, heat exchange happens between the cooling liquid in high temperature liquid state due to the heat absorbed from the battery and the coolant in state of low temperature liquid because of having passed through the expansion valve. In other words, the cooling liquid gives off the heat acquired from the battery and the coolant vaporizes by absorbing the heat. The exit of the selector valve can also be controlled to direct the cooling liquid to the heat sink to dissipate the heat. By means of the sink, the liquid is in full contact with air when passing through the sink so as to emit the heat via air. It is noted that the heat sink can also be replaced by a cooling plate, that is, heat exchange happens between the cooling liquid and the cooling plate for dissipation. Further, the battery cooling system further includes a pump driving the cooling liquid to circulate within the system. Additionally, the battery cooling system further includes a high voltage heater used for heating the cooling liquid, which is connected in parallel with the heat sink and the cooling device. By controlling the exit of the selector valve, the cooling liquid can be led to the high voltage heater. In this case, when the high voltage heater does not work, the cooling liquid travels through the high voltage heater with temperature remaining constant; when the high voltage heater works, it flows through the heater with the temperature being raised.

Further, the smart control system of the application further includes a battery thermal management system, which monitors battery temperature and controls the exit of the selector valve according to the temperature, leading the cooling liquid into the cooling device, the heat sink or the high temperature heater. Its object is to achieve different cooling effects by controlling the exit of the selector valve to make the cooling liquid flow through different circuits. In particular, by controlling the exit of the selector valve to direct the cooling liquid into the cooling device, the vehicle air conditioning system now works and heat exchange happens between the cooling liquid and the coolant within the air conditioning system, this way of cooling is referred to as active cooling. The cooling ability of the active cooling is the best and not affected by ambient temperature, but it consumes more power, because the vehicle air conditioning system as a high voltage device has to work. By controlling the exit of the selector valve to lead the cooling liquid into the heat sink, the cooling liquid in full contact with air now dissipates heat into air, this cooling way is referred to as passive cooling. This way of cooling needs simply such low voltage devices as a pump and a fan to work and thus consumes less power. However, the cooling ability of the passive cooling is affected by ambient temperature. The cooling liquid can also flow into the high voltage heater by controlling the exit of the selector valve; when this heater does not work, the temperature of the cooling liquid is constant, this way of cooling is referred to as bypass; if the heater works, this cooling way can be referred to as active heating.

On the basis of the advantages and disadvantages of the active and passive cooling ways of the above mentioned smart control system, the application also provides a smart method for controlling temperature of an electric vehicle battery pack. By monitoring the battery temperature with a battery thermal management system and making judgement based on the current battery state of charge (SOC) and its charging state, the method chooses suitable ways of cooling for different situations to cool down the battery pack, extending the lifetime of the battery pack under different situations without increasing costs.

With reference to FIG. 4, FIG. 4 is a flow chart of the smart method for controlling temperature of an electric vehicle battery pack in accordance with the present application. As shown in FIG. 4, the method includes the following steps: at step S101, the vehicle is powered off; at step S102, the operation of the thermal management is detected, if its duration is longer than a predetermined threshold, the operation will be suspended; if its duration is no longer than the threshold, then the method moves to step S103; at step S103, it is determined whether the battery is connected to a charging post (that is, whether the battery is being charged), when the battery is connected to a post, the method moves to step S106 so as to assess the temperature of the battery, then the method moves further to step S107, at which the current battery temperature is compared with a preset temperature range. Specifically, when the battery temperature is below the preset temperature range, the thermal management system stops working, when the temperature falls within the range, the method moves to step S108, at step S108, the above mentioned passive cooling way is chosen, that is, the thermal management system controls the selector valve to lead the cooling liquid to the heat sink, through which the cooling liquid is in full contact with air and thus gives off heat, when the battery temperature is above the preset temperature range, the method moves to step S109. At step S109, the previously described active cooling way is chosen, that is, the management system controls the selector valve to lead the cooling liquid to the cooling device, within which the cooling liquid is in heat exchange with the coolant of the vehicle air conditioning system and thus gives off heat. It is noted that when a battery is connected to a charging post, power required by the thermal management system can be provided by the post. In other words, the supply of power is adequate for the thermal management system. Therefore, there is no need to assess the battery SOC, meaning that the thermal management system doesn't rely on the battery SOC to work either in active or passive way which is selected according to the temperature of the battery, so long as the battery is connected to the charging post. Accordingly, the battery's temperature is directly evaluated without taking other factors into account when the battery is connected to the charging post.

On the other hand, when the battery is not connected to any charging post, battery SOC is relied on to supply power, because the vehicle air conditioning system will be turned on when the thermal management system works in the active cooling way. Therefore, when the battery is not connected to a charging post, it is necessary to determine the SOC level of the battery before the thermal management system employs active or passive cooling way. As shown in FIG. 4, when the battery is not connected to a charging post, the method moves to step S104, at which the battery's SOC is assessed, and then at step S105, the current battery SOC is compared with a preset battery SOC range. In particular, when the current battery SOC is lower than the preset SOC range, the thermal management is stopped from working, and when it falls within the preset range, the method moves to step S110, at which the battery temperature is assessed. The method also includes step S111, at which the current battery temperature is compared with a target temperature. Particularly, when the battery temperature is below the target temperature, the thermal management is stopped from working, and when it is above the target temperature, the method moves to step S112 and the passive cooling way is chosen, that is, the thermal management system controls the selector valve to direct the cooling liquid to the heat sink, by means of which the cooling liquid is in full contact with air and gives off heat. It is to be noted that when the battery SOC is low, the lifespan of the battery will not be shortened even in high temperature environment; as a result, the thermal management operation is stopped when the battery SOC is lower than the preset battery SOC range. When the battery SOC is within the preset battery SCO range, the battery temperature will somewhat influence its lifespan. Yet the battery SOC is not sufficient to maintain the active cooling, that is to say, the thermal management system does not have enough power to enable heat exchange between the vehicle air conditioner and the battery cooling system. On basis of this, a target temperature is preset, below which the battery's lifespan suffers no loss, the thermal management operation can thus be stopped; the battery needs cooling when its temperature is above the target temperature, therefore the passive cooling way (with lower energy consumption) can be chosen to decrease the temperature of the battery.

Referring still to FIG. 4, when the current battery SOC level is above the preset battery SOC range, the SOC power of the battery is sufficient to energize the vehicle air conditioning system, that is to say, in the case of sufficient battery SOC power, either active or passive cooling way can be chosen to cool the battery. On the basis of this, that is, when the current battery SOC is higher than the preset battery SOC range, the method moves to step S106, at which the battery temperature is assessed. As mentioned above, the method further moves from step S106 to step S107, at which the current battery temperature is compared with the preset temperature range. Specifically, when the current battery temperature is below the preset temperature range, the thermal management operation is stopped, when the current battery temperature is within the present temperature range, the method moves to step S108, the passive cooling way is chosen, that is, the selector valve is controlled by the thermal management system to direct the cooling liquid to the heat sink, through which the cooling liquid is in full contact with air and gives off heat, because the battery temperature does not cause severe harm to the lifespan of the battery at this time; when the battery temperature is higher than the preset temperature range, the method moves to step S109, the active cooling way is chosen, meaning that the selector valve is controlled by the management system to lead the cooling liquid to the cooling device, within which the heat exchange happens between the cooling liquid and the coolant of the vehicle air conditioning system to emit heat, because the battery temperature now does severe harm to battery lifespan.

In a word, the smart control method of the application is able to carry out different battery cooling schemes through monitoring the battery temperature in accordance with different conditions of the battery, such as whether the battery is on charge or not and its SOC range, thereby extending the lifespan of the battery. Additionally, assessment of battery temperature and the operations carried out according to the battery temperature, for example the active or passive cooling or the halt of thermal management operation, are all executed in a closed loop way, that is to say, the temperature of battery is constantly changing during its cooling operation. Accordingly, when the battery is managed in respective ways, the battery state is monitored in real time and the management scheme is also adjusted in real time.

It should be readily understood by those skilled in the art that the previously mentioned target temperature, the preset temperature range and the preset battery SOC range can be determined according to actual situation. Specifically, the preset battery SOC range in the present application may be 10%-80%, 20%-60 or 25%-45%, which is merely illustrative. In addition, when the battery SOC is not sufficient to maintain the active way of cooling, a target temperature can be set, above which the battery is cooled in passive way and below which the thermal management operation is stopped. When the battery SOC has enough power to maintain any kind of cooling, there are now three choices for the battery: active cooling, passive cooling and stopping the thermal management operation. Hence, it is necessary to set a temperature range beforehand, according to which different ways of cooling are chosen. The temperature level or range can also be determined by the skilled person in the art according to actual situation.

So far the technical solutions of the present application has been described in connection with the preferred embodiments given in connection with the accompanying figures, it will be readily understood by those skilled in the art that the protection scope of the application is obviously not limited to these specific embodiments. Without departing from the principles of the application, equivalent alterations or substitutions of related technical features can be made by those skilled in the art; these altered or substituted technical solutions will fall within the protection scope of the application.

What is claimed is:

1. A smart system for controlling battery pack temperature of an electric vehicle, comprising a battery cooling system, a vehicle air conditioning system and a cooling device,
both cooling liquid of the battery cooling system and coolant of the vehicle air conditioning system flow through the cooling device and exchange heat within the cooling device;
the battery cooling system includes a heat sink to dissipate heat from the cooling liquid and a selector valve used for directing the cooling liquid into the cooling device or the heat sink.

2. The smart system for controlling battery pack temperature of an electric vehicle as set forth in claim 1, wherein the battery cooling system further includes a pump to circulate the cooling liquid.

3. The smart system for controlling battery pack temperature of an electric vehicle as set forth in claim 2, wherein the battery cooling system further includes a high voltage heater connected in parallel with the heat sink and used for heating the cooling liquid which can also be led to the high voltage heater by controlling the selector valve.

4. The smart system for controlling battery pack temperature of an electric vehicle as set forth in claim 3, wherein the vehicle air conditioning system includes a compressor, a condenser, an expansion valve, and a dryer/separator communicated with one another, coolant is first compressed by the compressor, then passes through the condenser and is liquefied, thereafter, the coolant passes through the expansion valve to bring down its temperature and pressure and flows into the cooling device, within which heat exchange happens between the coolant and the cooling liquid, the coolant then travels through the dryer/separator and finally enters back to the compressor in gas state, completing a whole circulation.

5. The smart system for controlling battery pack temperature of an electric vehicle as set forth in claim 4, wherein the vehicle air conditioning system further includes a cooling fan, which operates in cooperation with the condenser to improve the performance of the condenser.

6. The smart system for controlling battery pack temperature of an electric vehicle as set forth in claim 1, wherein the smart control system further includes a battery thermal management system, which is used for monitoring battery temperature and controlling the selector valve according to the battery temperature so as to lead the cooling liquid into the cooling device, the heat sink or the high voltage heater.

7. A smart control method used for the smart system for controlling battery pack temperature of an electric vehicle of claim 6, comprising the following steps:
when the vehicle is powered off, determining whether the duration of the thermal management operation is longer than a predetermined threshold;
suspending the thermal management operation, if the duration is longer than the threshold;
if the duration is no longer than the threshold, determining whether the battery is in charging state or not;
if the battery is in charging state, assessing the temperature of the battery;
if the battery is not in charging state, assessing the battery SOC and choosing to stop the thermal management operation or assess the battery temperature in accordance with the assessment of the battery SOC;
comparing the assessment result of the battery temperature with a target temperature or preset temperature range, and executing the following operations based on the comparison: stop the thermal management operation, the thermal manage system directs the cooling liquid to the cooling device or the heat sink by controlling the selector valve.

8. The smart control method as set forth in claim 7, wherein the step of if the battery is in charging state, assessing the temperature of the battery, further includes the following steps:
comparing the current battery temperature with the preset temperature range;
if the current battery temperature is below the preset temperature range, stopping the thermal management operation;
if the current battery temperature is within the preset temperature range, the thermal management operation system controls the selector valve to lead the cooling liquid to the heat sink;
if the current battery temperature is above the preset temperature range, the thermal management operation system controls the selector valve to direct the cooling liquid to the cooling device and opens the vehicle air conditioning system at the same time.

9. The smart control method as set forth in claim 7, wherein the step of if the battery is not in charging state, assessing the battery SOC and choosing to stop the thermal management operation or assess the battery temperature in accordance with the assessment of the battery SOC, further includes the following steps:
comparing the current battery SOC with the preset battery SOC range;
if the current battery SOC is below the preset battery SOC range, stopping the thermal management operation;
if the current battery SOC is within or above the preset battery SOC range, then assessing the battery temperature.

10. The smart control method as set forth in claim 9, wherein the step of if the current battery SOC is within the preset battery SOC range, then assessing the battery temperature, further includes the following steps:
comparing the battery temperature with a target temperature;
if the battery temperature is below the target temperature, then stopping the thermal management operation;
if the battery temperature is above the target temperature, then controlling the selector valve to direct the cooling liquid to the heat sink.

11. The smart control method as set forth in claim 9, wherein the step of if the current battery SOC is above the preset battery SOC range, then assessing the battery temperature, further includes the following steps:
comparing the battery temperature with a preset temperature range;
if the battery temperature is below the preset temperature range, stopping the thermal management operation;
if the battery temperature is within the preset temperature range, the thermal management system controls the selector valve to direct the cooling liquid to the heat sink;
if the current battery temperature is above the preset temperature range, the thermal management system controls the selector valve to direct the cooling liquid to the cooling device and opens the vehicle air conditioning system at the same time.

12. The smart control method as set forth in claim 9, wherein the preset battery SOC range comprises 10%-80%, 20%-60% or 25%-45%.
